(19) United States
(12) Patent Application Publication
(10) Pub. No.: US 2010/0309646 A1
(43) Pub. Date: Dec. 9, 2010

(54) LIGHT-EMITTING DEVICE AND DISPLAY UNIT AND LIGHTING UNIT USING THE SAME

(75) Inventors: Makoto Morikawa, Nara (JP); Tetsushi Tamura, Osaka (JP); Kenji Ueda, Nara (JP); Hiroyuki Imamura, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/440,179

(22) PCT Filed: Oct. 17, 2007
(86) PCT No.: PCT/JP2007/070684

§ 371 Date: Mar. 5, 2009

(30) Foreign Application Priority Data
Oct. 19, 2006 (JP) 2006-285238

(51) Int. Cl. F21V 9/16; F21V 7/00; F21V 7/06

(52) U.S. Cl. 362/84; 362/235

(57) ABSTRACT

A light-emitting device (1) includes a base (10), a light reflecting member (11) placed on the base (10), a case (12) surrounding the light reflecting member (11), and a plurality of light-emitting elements (13) arranged on the inner surface of the case (12). The light reflecting member (11) reflects light emitted from an emission source including the light-emitting elements (13) toward an opening (12a) of the case (12). In the light-emitting device (1), since a plurality of light-emitting elements (13) can be arranged three-dimensionally, the size of the light-emitting device can be reduced easily. Moreover, the light reflecting member (11) reflects light emitted from the emission source including the light-emitting elements (13) toward the opening (12a) of the case (12), so that the light-emitting device can have high brightness.

### TECHNICAL FIELD

The present invention relates to a light-emitting device including a plurality of light-emitting elements, and a display unit and a lighting unit that use the light-emitting device.

### BACKGROUND ART

A light-emitting element such as a light-emitting diode (referred to as “LED” in the following) has been used in various types of light-emitting devices. Compared to existing light sources using discharge or radiation, the LED has a smaller size and higher efficiency, and the luminous flux of the LED also has increased significantly in recent years. Therefore, the LED is expected to replace the existing light sources. For example, JP 2003-124528 A discloses a light-emitting device that may achieve high brightness by mounting many LED chips on a card-type substrate with a high density

However, when many LED chips are used like the light-emitting device of JP 2003-124528 A, it is difficult to reduce the size of the device, since the light-emitting portion becomes larger.

JP 2004-63335 A proposes a light-emitting device in which a plurality of LED chips are arranged on the inner surface (light reflecting surface) of a rod-shaped member. With this configuration, the light-emitting device may be smaller in size and higher in brightness.

However, in the light-emitting device of JP 2004-63335 A, light from the LED chips is reflected by the inner surface of the rod-shaped member before exiting from the end of the rod-shaped. member. Therefore, the intensity of the light is attenuated while a part of the light from the LED chips is reflected repeatedly by the inner surface of the rod-shaped member. Consequently, a part of the light from the LED chips cannot be extracted as emitted light, making it difficult to achieve high brightness.

### DISCLOSURE OF INVENTION

To solve the above problems, the present invention provides a light-emitting device that can achieve both a small size and high brightness, and a display unit and a lighting unit that use the light-emitting device.

A light-emitting device of the present invention includes a base, a light reflecting member placed on the base, a case surrounding the light reflecting member, and a plurality of light-emitting elements arranged on an inner surface of the case. The light reflecting member reflects light emitted from an emission source including the light-emitting elements toward an opening of the case.

A display unit and a lighting unit of the present invention include the light-emitting device of the present invention as a light source.

In the light-emitting device of the present invention, since a plurality of light-emitting elements can be arranged three-dimensionally, the size of the light-emitting device can be reduced easily. Moreover, the light reflecting member reflects light emitted from the emission source including the light-emitting elements toward the opening of the case. Therefore, the light-emitting device can have high brightness. Both the display unit and the lighting unit of the present invention include the above light-emitting device of the present invention as a light source, and thus can achieve a small size and high brightness.

### BRIEF DESCRIPTION OF DRAWINGS

FIG. 1A is a schematic perspective view showing a light-emitting device of Embodiment 1 of the present invention.

FIG. 1B is a schematic cross-sectional view of the light-emitting device shown in FIG. 3A.

FIGS. 2A to 2D are schematic cross-sectional views showing modified examples of a light-emitting device of Embodiment 1 of the present invention.

FIG. 3 is a schematic cross-sectional view showing a light-emitting device of Embodiment 2 of the present invention.

FIG. 4 is a schematic cross-sectional view showing a light-emitting device of Embodiment 3 of the present invention.

FIG. 5 is a schematic cross-sectional view showing a light-emitting device of Embodiment 4 of the present invention.

FIG. 6 is a schematic cross-sectional view showing a light-emitting device of Embodiment 5 of the present invention.

FIG. 7 is a schematic cross-sectional view showing a light-emitting device of Embodiment 6 of the present invention.

FIG. 8 is a schematic cross-sectional view showing a light-emitting device of Embodiment 7 of the present invention.

FIG. 9 is a schematic cross-sectional view showing a light-emitting device of Embodiment 8 of the present invention.

FIG. 10 is a schematic cross-sectional view showing a light-emitting device of Embodiment 9 of the present invention.

FIG. 11 is a perspective view showing an image display apparatus of Embodiment 10 of the present invention.

FIG. 12 is a perspective view showing a desktop lamp of Embodiment 11 of the present invention.

### DESCRIPTION OF THE INVENTION

The light-emitting device of the present invention includes a base, a light reflecting member placed on the base, a case surrounding the light reflecting member, and a plurality of light-emitting elements arranged on an inner surface of the case. The light-emitting elements may be mounted on the inner surface by die bonding, wire bonding, flip-chip bonding, eutectic bonding such as Au—Sn, adhesion bonding such as Au—Au, pressure bonding using an anisotropic conductive film (ACF) or the like, bonding with an adhesive such as Ag paste, etc. According to the present invention, since a plurality of light-emitting elements can be arranged three-dimensionally, the size of the light-emitting device can be reduced easily. The number of the light-emitting elements is not particularly limited, as long as two or more light-emitting elements are provided, and may be determined appropriately depending on the amount of light required.

The material of the base is not particularly limited. Examples of the material include the following: single crystals such as sapphire, Si, GaN, AIN, ZnO, SiC, BN, and ZnS; ceramics such as Al₂O₃, AlN, BN, MgO, ZnO, SiC, and C or a mixture thereof, metals such as Al, Cu, Fe, Au, W, and an alloy including these metals; resins such as an epoxy resin, silicone resin, acrylic resin, urea resin, amide resin, imide resin, polycarbonate resin, polyphenylene sulfide resin, liquid crystal polymer, acrylonitrile butadiene styrene resin (ABS resin), methacrylic resin (PMMA resin), and cyclic olefin copolymer or a mixture of these resins; a laminated material obtained by bonding a metal plate to any of the above resins; glass; glass epoxy; and muscovite.

It is preferable that at least a part of the inner surface of the case is a light reflecting surface because the light extraction efficiency can be improved. In this case, the entire inner surface of the case is not necessarily the light reflecting surface. For example, the surface on which the light-emitting elements are mounted does not have to be the light reflecting surface. Examples of the material of the light reflecting surface include the following: metals such as Al, Ag, Au, Ni, Rh, Pd, and an alloy including these metals; metallic oxides such as an aluminum oxide, ceric oxide, hafnium oxide, magnesium oxide, niobium oxide, tantalum oxide, zirconium oxide, zinc oxide, titanium oxide, yttrium oxide, silicon oxide, indium oxide, tin oxide, tungsten oxide, and vanadium oxide; and inorganic materials such as silicon nitride, gallium nitride, silicon carbide, calcium fluoride, calcium carbonate, copper sulfide, tin sulfide, zinc sulfide, and barium sulfide or a mixture thereof. When a particulate metallic oxide or inorganic material is used, the average particle size is preferably 0.3 to 3 μm in view of the reflection effect due to diffusion and scattering. Moreover, a distributed Bragg reflector (thickness: 0.1 to 1 μm) including a multilayer film in which two or more types of the metallic oxides or inorganic materials are stacked alternately is effective for the material of the light reflecting surface. The surface of the base formed of the above materials also can be used as the light reflecting surface. For example, the case may be formed of a resin material or ceramics material having a high surface reflectance. The base and the case may be formed integrally by using the same material.

The shape of the case is not particularly limited. For example, the cross section of the case perpendicular to the light emission direction of the light-emitting device may be in the form of a circle, an ellipse, or a polygon (i.e., a polygon with at least three sides). Moreover, the inner surface of the case may become wider toward the opening. This configuration can improve the light extraction efficiency.

The light reflecting member reflects light emitted from the emission source including the light-emitting elements toward the opening of the case. In this context of the present invention, the “light emitted from the emission source including the light-emitting elements” indicates not only light from the light-emitting elements, but also converted light from phosphor layers, which will be described later.

The material of the light reflecting member can be the same as those of the light reflecting surface. Among them, a heat radiation material such as a metal (Al, Ag, Au, etc.) is preferred because heat generated by the light-emitting elements can be radiated efficiently. In particular, when the case is filled with a phosphor layer (as described later), effective heat radiation can be performed. It is also possible to use a material obtained by coating a core material such as a resin with a light reflecting material such as a metal for the light reflecting member.

The shape of the light reflecting member is not particularly limited. For example, it may be a convex body having an inclined surface on which light emitted from the emission source including the light-emitting elements can be reflected toward the opening of the case. Such a convex body may be substantially in the form of a cone or hemisphere. In this specification, the term “substantial” or “substantially” used for describing a particular shape means not only the exact shape but also a modified shape having the same function. Specific examples of the substantial cone include a circular cone, a polygonal pyramid, an elliptical cone, a truncated circular cone, a truncated polygonal pyramid, a truncated elliptical cone, and any modified shapes having the same function as these cones.

The light-emitting element may be, e.g., a red LED for emitting red light with a wavelength of 600 to 660 nm, a yellow LED for emitting yellow light with a wavelength of 550 to 600 nm, a green LED for emitting green light with a wavelength of 500 to 550 nm, a blue LED for emitting blue light with a wavelength of 420 to 500 nm, or a blue-violet LED for emitting blue-violet light with a wavelength of 380 to 420 nm. Moreover, the light-emitting element may be a LED combined with a phosphor such as a white LED including the blue LED and a yellow phosphor for emitting white light or a white LED including the blue-violet or violet LED and blue, green and red phosphors for emitting white light. A LED for emitting near infrared light (660 to 780 nm) or infrared light (780 nm to 2 μm) also can be used. The red and yellow LEDs may be formed of, e.g., a AlInGaP material. The green, blue, blue-violet, and violet LEDs may be formed of, e.g., a InGaAlN material. The LED for emitting near infrared light or infrared light may be formed of, e.g., a AlGaAs or InGaAsP material. The composition ratio of the elements of the LED materials formed by epitaxial growth may be adjusted appropriately in accordance with the emission wavelength.

In the light-emitting device of the present invention, the light reflecting member may be in the form of a cone with a substantially parabolic side or a truncated cone with a substantially parabolic side, and at least one light-emitting element may be located at the position of a substantial focus of a substantial parabola defining the parabolic side of the light reflecting member in the cross section of the light-emitting device that is taken along the direction perpendicular to the base and passes through the at least one light-emitting element and the axis of the light reflecting member. With this configuration, light from the light-emitting element located at the position of the substantial focus of the substantial parabola is reflected by the parabolic side of the light reflecting member and travels in a straight line toward the opening of the case. Therefore, the extraction efficiency of light exiting from the opening can be improved.

The light-emitting device of the present invention further may include phosphor layers for covering the light-emitting elements. This allows light from the light-emitting elements and converted light from the phosphor layers to be mixed, so that white light can be extracted. In such a case, the phosphor layers may cover each of the light-emitting elements. Alternatively, one phosphor layer may cover a plurality of light-emitting elements.

The phosphor layer may include a translucent material such as an epoxy resin, silicone resin, or acrylic resin and a phosphor dispersed in the translucent material.

As the phosphor, e.g., a red phosphor for emitting red light, an orange phosphor for emitting orange light, a yellow phosphor for emitting yellow light, or a green phosphor for emitting green light can be used. Examples of the red phosphor include silicate Ba₃MgSi₂O₈:Eu²⁺, Mn²⁺, nitridosilicate Sr₂Si₅N₈:Eu²⁺, nitridoaluminosilicate CaAlSiNₛ:Eu²⁺, oxo-nitridoaluminosilicate Sr₂Si₄AlON₇:Eu²⁺, and sulfide (Sr, Ca)S Eu²⁺ or La₂O₂S:Eu³⁺, Sm³⁺. Examples of the orange phosphor include silicate (Sr, Ca)₂SiO₄:Eu²⁺, garnet Gd₃Al₅O₁₂:Ce³⁺, and α-SIALON Ca-α-SiAlON:Eu²⁺. Examples of the yellow phosphor include silicate (Sr, Ba)₂SiO₄:Eu²⁺ or Sr₃SiO₅:Eu²⁺, garnet (Y, Gd)₃Al₅O₁₂:Ce³⁺, sulfide CaGa₂S₄:Eu²⁺, and α-SIALON Ca-α-SiAlON:Eu²⁺. Examples of the green phosphor include aluminate BaMgAl₁₀O₁₇:Eu²⁺, Mn²⁺ or (Ba, Sr, Ca)Al₂O₄:Eu²⁺, silicate (Ba, Sr)₂SiO₄:Eu²⁺, α-SIALON Ca-α-SiAlON Yb²⁺, β-SIALON β-Si₃N₄:Eu²⁺, oxo-nitridosilicate (Ba, Sr, Ca)Si₂O₂N₂:Eu²⁺, oxo-nitridoaluminosilicate (Ba, Sr, Ca)₂Si₄AlON₇:Ce³⁺, sulfide SrGa₂S₄:Eu²⁺, garnet Y₃(Al, Ga)₅O₁₂:Ce³⁺, and oxide CaSc₂O₄:Ce³⁺.

When the blue-violet or ultraviolet LED is used as the light-emitting element, e.g., the above phosphors may be used with a blue phosphor for emitting blue light or a cyan phosphor for emitting cyan light. Examples of the blue phosphor include aluminate BaMgAl₁₀O₁₇:Eu²⁺, silicate Ba₃MgSi₂O₈:Eu²⁺, and halophosphate (Sr, Ba)₁₀(PO₄)₆Cl₂:Eu²⁺. Examples of the cyan phosphor include aluminate Sr₄Al₁₄O₂₅:Eu²⁺ and silicate Sr₂Si₃O₈.2SRCl₂:Eu²⁺.

When the light-emitting device includes the phosphor layers, the light reflecting member may be in the form of a cone with a substantially parabolic side or a truncated cone with a substantially parabolic side, and the central portion of the emission surface of a phosphor layer may be located at the position of a substantial focus of a substantial parabola defining the parabolic side of the light reflecting member in the cross section of the light-emitting device that is taken along the direction perpendicular to the base and passes through the central portion of the emission surface of the phosphor layer and the axis of the light reflecting member. With this configuration, light from the central portion located at the position of the substantial focus of the substantial parabola is reflected by the parabolic side of the light reflecting member and travels in a straight line toward the opening of the case. Therefore, the extraction efficiency of light exiting from the opening can be improved.

The light-emitting device of the present invention further may include a phosphor layer for covering the opening of the case. This allows light from the light-emitting elements and converted light from the phosphor layer to be mixed, so that white light can be extracted. In such a case, the phosphor layer can use the same materials as described above.

The light-emitting device of the present invention further may include a phosphor layer filled into the case. This allows light from the light-emitting elements and converted light from the phosphor layer to be mixed, so that white light can be extracted. In such a case, the phosphor layer also can use the same materials as described above.

The light-emitting device of the present invention further may include condenser lenses for covering the light-emitting elements. This allows light from the light-emitting elements to be directed efficiently to the light reflecting member. In such a case, the condenser lenses may cover each of the light-emitting elements. Alternatively, one condenser lens may cover a plurality of light-emitting elements.

The light-emitting device of the present invention further may include a condenser lens for covering the opening of the case. This allows the radiation pattern of emitted light to be controlled easily.

The light-emitting device of the present invention further may include a heat sink that is in contact with the outer surface of the case. This allows heat generated by the light-emitting elements to be radiated efficiently. The material of the heat sink may be metal such as copper, aluminum, gold, or silver. In this case, the entire outer surface of the case does not need to be covered with the heat sink as long as heat generated by the light-emitting elements can be radiated.

Both the display unit and the lighting unit of the present invention include the above light-emitting device of the present invention as a light source. Thus, the display unit and the lighting unit can achieve a small size and high brightness for the same reason as described above.

Hereinafter, embodiments of the present invention will be described with reference to the drawings. In the drawings, the components having substantially the same function are denoted by the same reference numerals, and the explanation will not be repeated. For the purpose of making the drawings easier to understand, metal wiring or a feed terminal that is located outside the light-emitting device is omitted from the drawings.

### EMBODIMENT 1

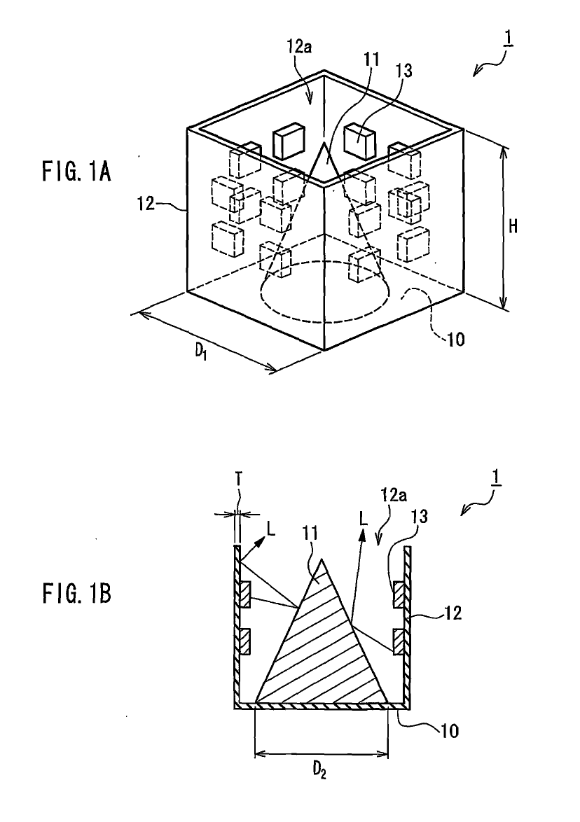

FIG. 1A is a schematic perspective view showing a light-emitting device of Embodiment 1 of the present invention, and FIG. 1B is a schematic cross-sectional view of the light-emitting device shown in FIG. 1A.

As shown in FIGS. 1A and 1B, the light-emitting device 1 includes a base 10, a light reflecting member 11 placed on the base 10, a case 12 surrounding the light reflecting member 11, and a plurality of light-emitting elements 13 arranged on the inner surface (light reflecting surface) of the case 12. The cross section of the case 12 perpendicular to the light emission direction of the light-emitting device 1 is in the form of a quadrangle (the length D₁ of each side is 4 to 10 mm) The wall thickness T of the case 12 is 0.025 to 1.5 mm The height H of the case 12 is 4 to 10 mm The light reflecting member 11 is substantially conical in shape, whose base has a diameter D₂ of 2.8 to 8.8 mm. The light reflecting member 11 reflects light L emitted from each of the light-emitting elements 13 toward an opening 12a of the case 12. With this configuration, the light-emitting device 1 can achieve both a small size and high brightness.

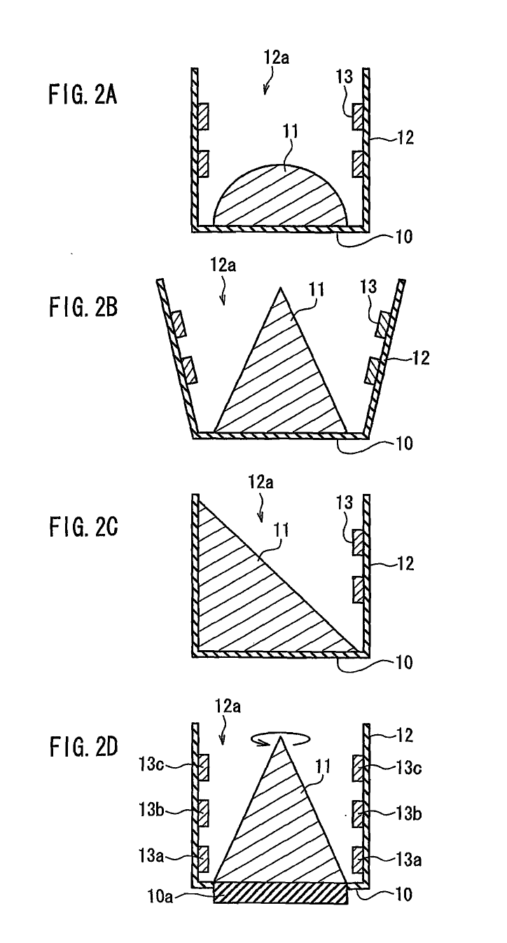

Although the light-emitting device 1 of Embodiment 1 of the present invention has been described above, the present invention is not limited to this embodiment. For example, as shown in FIG. 2A, the light reflecting member 11 may be substantially hemispherical in shape. Moreover, as shown in FIG. 2B, the inner surface of the case 12 may become wider toward the opening 12a. The configuration of FIG. 2B can improve the extraction efficiency of light exiting from the opening 12a. As shown in FIG. 2C, a part of the side of the light reflecting member 11 may come into contact with the inner surface of the case 12. As shown in FIG. 2D, a rotation mechanism 10a may be provided in the center of the base 10 so as to rotate the light reflecting member 11. The configuration of FIG. 2D can suppress nonuniformity in the illuminance of light extracted, since portions on which the light is incident are spread out over the light reflecting member 11. In this case, the light reflecting member 11 may be formed helically. The rotation of such a helical light reflecting member 11 generates an air current inside the case 12, and thus heat from the light-emitting elements 13 can be radiated efficiently. In the configuration of FIG. 2D, the light-emitting elements 13a located closer to the base 10 are red LEDs, the light-emitting elements 13c located closer to the opening 12a of the case 12 are blue LEDs, and the light-emitting elements 13b located between the light-emitting elements 13a and 13c are green LEDs. This arrangement of the light-emitting elements can prevent reabsorption of light between the light-emitting elements with different emission colors.

### EMBODIMENT 2

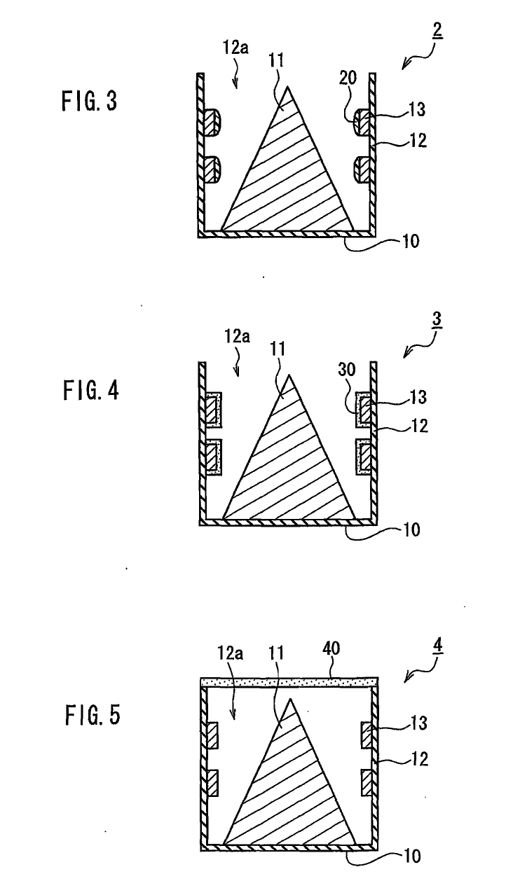

FIG. 3 is a schematic cross-sectional view showing a light-emitting device of Embodiment 2 of the present invention.

As shown in FIG. 3, the light-emitting device 2 further includes condenser lenses 20 for covering each of the light-emitting elements 13, in addition to the above configuration of the light-emitting device 1. With this configuration, the light from the light-emitting elements 13 can be directed efficiently to the light reflecting member 11.

### EMBODIMENT 3

FIG. 4 is a schematic cross-sectional view showing a light-emitting device of Embodiment 3 of the present invention.

As shown in FIG. 4, the light-emitting device 3 further includes phosphor layers 30 for covering each of the light-emitting elements 13, in addition to the above configuration of the light-emitting device 1. With this configuration, the light from the light-emitting elements 13 and the converted light from the phosphor layers 30 are mixed, so that white light can be extracted.

### EMBODIMENT 4

FIG. 5 is a schematic cross-sectional view showing a light-emitting device of Embodiment 4 of the present invention.

As shown in FIG. 5, the light-emitting device 4 further includes a phosphor layer 40 (phosphor plate) for covering the opening 12a of the case 12, in addition to the above configuration of the light-emitting device 1. With this configuration, the light from the light-emitting elements 13 and the converted light from the phosphor layer 40 are mixed, so that white light can be extracted.

### EMBODIMENT 5

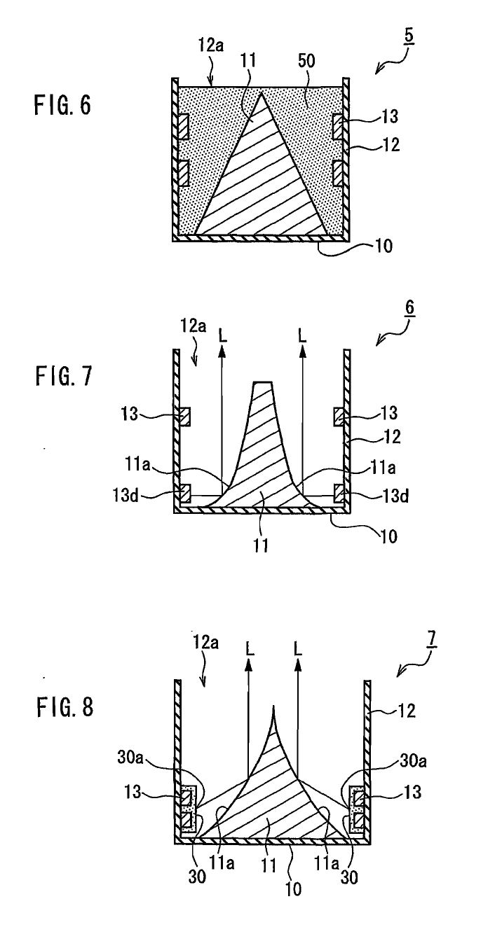

FIG. 6 is a schematic cross-sectional view showing a light-emitting device of Embodiment 5 of the present invention.

As shown in FIG. 6, the light-emitting device 5 further includes a phosphor layer 50 filled into the case 12, in addition to the above configuration of the light-emitting device 1. With this configuration, the light from the light-emitting elements 13 and the converted light from the phosphor layer 50 are mixed, so that white light can be extracted.

### EMBODIMENT 6

FIG. 7 is a schematic cross-sectional view showing a light-emitting device of Embodiment 6 of the present invention.

As shown in FIG. 7, the light-emitting device 6 includes the light-reflecting member 11 in the form of a truncated cone with a substantially parabolic side 11a. Some of the light-emitting elements 13d are located at the positions of substantial focuses of substantial parabolas defining the parabolic side 11a of the light reflecting member 11. With this configuration, the light L from the light-emitting element 13d located at the position of the substantial focus of the substantial parabola is reflected by the parabolic side 11a of the light reflecting member 11 and travels in a straight line toward the opening 12a of the case 12. Therefore, the extraction efficiency of light exiting from the opening 12a can be improved.

### EMBODIMENT 7

FIG. 8 is a schematic cross-sectional view showing a light-emitting device of Embodiment 7 of the present invention.

As shown in FIG. 8, the light-emitting device 7 includes the light reflecting member 11 in the form of a cone with a substantially parabolic side 11a. The light-emitting device 7 also includes phosphor layers 30, each of which covers a plurality of light-emitting elements 13. Moreover, the central portions 30a of the emission surfaces of the phosphor layers 30 are located at the positions of substantial focuses of substantial parabolas defining the parabolic side 11a of the light reflecting member 11. With this configuration, the light L from the central portion 30a located at the position of the substantial focus of the substantial parabola is reflected by the parabolic side 11a of the light reflecting member 11 and travels in a straight line toward the opening 12a of the case 12. Therefore, the extraction efficiency of light exiting from the opening 12a can be improved.

### EMBODIMENT 8

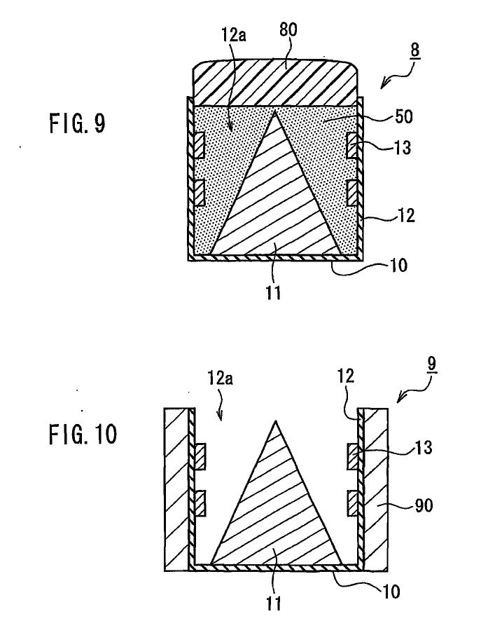

FIG. 9 is a schematic cross-sectional view showing a light-emitting device of Embodiment 8 of the present invention.

As shown in FIG. 9, the light-emitting device 8 further includes a condenser lens 80 for covering the opening 12a of the case 12, in addition to the above configuration of the light-emitting device 5 (see FIG. 6). With this configuration, the radiation pattern of light emitted from the opening 12a can be controlled easily.

### EMBODIMENT 9

FIG. 10 is a schematic cross-sectional view showing a light⁻emitting device of Embodiment 9 of the present invention.

As shown in FIG. 10, the light-emitting device 9 further includes a heat sink 90 that is in contact with the outer surface of the case 12, in addition to the above configuration of the light-emitting device 1 (see FIGS. LA and 1B). With this configuration, heat generated by the light-emitting elements 13 can be radiated efficiently.

### EMBODIMENT 10

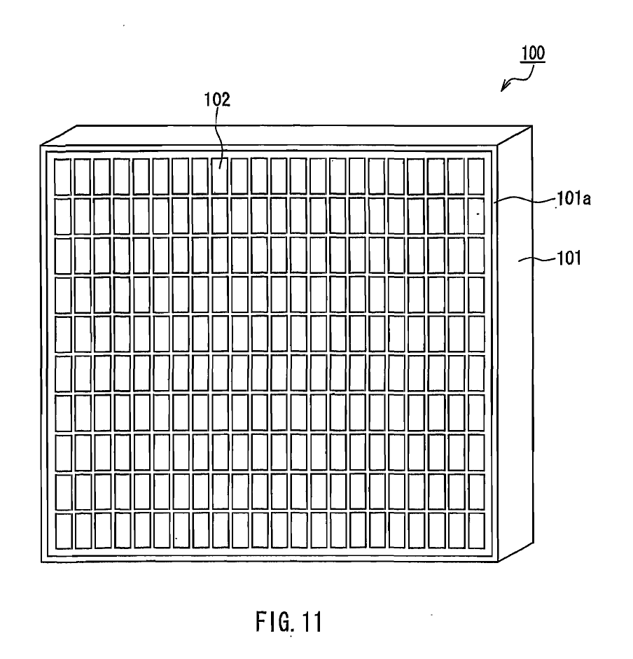

Next, a display unit (image display apparatus) of Embodiment 10 of the present invention will be described with reference to the drawings. FIG. 11 is a perspective view showing the image display apparatus of Embodiment 10 of the present invention.

As shown in FIG. 11, the image display apparatus 100 includes a panel 101. A plurality of light-emitting devices 102 according to any one of Embodiments 1 to 9 are arranged in a matrix form on a principal surface 101a of the panel 101 as light sources. The image display apparatus 100 with this configuration can achieve both a small size and high brightness because the light-emitting devices 102 according to any one of Embodiments 1 to 9 are used as light sources.

### EMBODIMENT 11

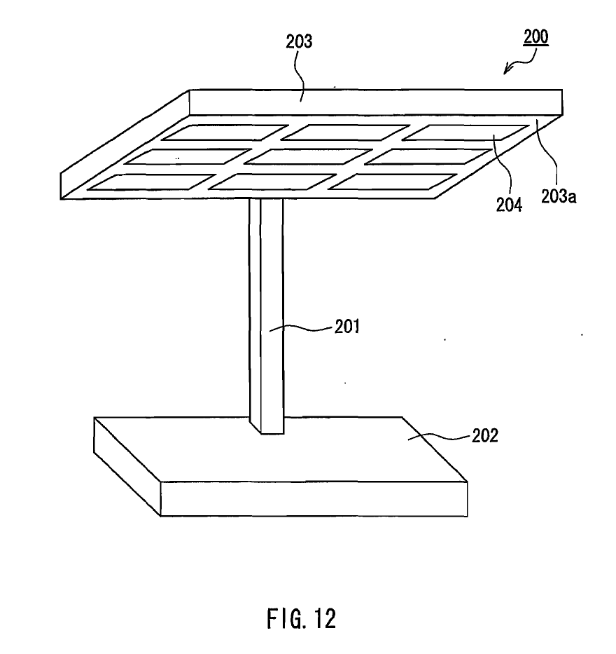

Next, a lighting unit (desktop lamp) of Embodiment 11 of the present invention will be described with reference to the drawings. FIG. 12 is a perspective view showing the desktop lamp of Embodiment 11 of the present invention.

As shown in FIG. 12, the desktop lamp 200 includes a neck 201, a base 202 that is fixed at one end of the neck 201 for supporting the neck 201, and a lighting portion 203 that is fixed at the other end of the neck 201. A plurality of light-emitting devices 204 according to any one of Embodiments 1 to 9 are arranged in a matrix form on a principal surface 203a of the lighting portion 203 as light sources. The desktop lamp 200 with this configuration can achieve both a small size and high brightness because the light-emitting devices 204 according to any one of Embodiments 1 to 9 are used as light sources.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

A light-emitting device of the present invention is useful for a lighting unit used, e.g., in general lighting applications, lighting for presentation purposes (a spotlight, a sign light, etc.), or vehicle lighting (particularly a headlight) or a display unit used, e.g., in displays or projectors. Moreover, the light-emitting device also is useful for a sensor light source that is required to be smaller and thinner.

1. A light-emitting device comprising:
a base;
a light reflecting member placed on the base;
a case surrounding the light reflecting member; and
a plurality of light-emitting elements arranged on an inner surface of the case,
wherein the case is formed as a part of the base, and
the light reflecting member reflects light emitted from an emission source including the light-emitting elements toward an opening of the case.

2. The light-emitting device according to claim 1, wherein the light reflecting member is formed of a heat radiation material.

3. The light-emitting device according to claim 1, wherein the light reflecting member is substantially in the form of a cone or hemisphere.

4. The light-emitting device according to claim 1, wherein at least a part of the inner surface of the case is a light reflecting surface.

5. The light-emitting device according to claim 1, wherein a cross section of the case perpendicular to a light emission direction of the light-emitting device is in the form of a circle, an ellipse, or a polygon.

6. (canceled)

7. The light-emitting device according to claim 1, wherein the light reflecting member is in the form of a cone with a substantially parabolic side or a truncated cone with a substantially parabolic side, and
at least one light-emitting element is located at a position of a substantial focus of a substantial parabola defining the parabolic side of the light reflecting member in a cross section of the light-emitting device that is taken along a direction perpendicular to the base and passes through the at least one light-emitting element and an axis of the light reflecting member.

8. The light-emitting device according to claim 1, further comprising phosphor layers for covering the light-emitting elements.

9. The light-emitting device according to claim 1, further comprising phosphor layers for covering the light-emitting elements,
wherein the light reflecting member is in the form of a cone with a substantially parabolic side or a truncated cone with a substantially parabolic side, and
a central portion of an emission surface of the phosphor layer is located at a position of a substantial focus of a substantial parabola defining the parabolic side of the light reflecting member in a cross section of the light-emitting device that is taken along a direction perpendicular to the base and passes through the central portion of the emission surface of the phosphor layer and an axis of the light reflecting member.

10. The light-emitting device according to claim 1, further comprising a phosphor layer for covering the opening of the case.

11. The light-emitting device according to claim 1, further comprising a phosphor layer filled into the case.

12. The light-emitting device according to claim 1, further comprising condenser lenses for covering the light-emitting elements.

13. The light-emitting device according to claim 1, further comprising a condenser lens for covering the opening of the case.

14. The light-emitting device according to claim 1, further comprising a heat sink that is in contact with an outer surface of the case.

15. A display unit comprising the light-emitting device according to claim 1 as a light source.

16. A lighting unit comprising the light-emitting device according to claim 1 as a light source.

17. The light-emitting device according to claim 1, wherein the light-emitting elements are arranged within a portion of the inner surface at the same pitch in both horizontal and vertical directions so that a height of the portion from the base is less than half the height of the light reflecting member.

18. The light-emitting device according to claim 1, wherein the inner surface of the case is inclined so as to become wider toward the opening.

19. The light-emitting device according to claim 3, wherein a rotation mechanism is provided in a center of the base so as to rotate the light reflecting member.
